(19) United States
(12) Patent Application Publication
(10) Pub. No.: US 2012/0076327 A1
(43) Pub. Date: Mar. 29, 2012

(54) Microphone windscreen covers

(76) Inventors: Brenda Benn, Hattiesburg, MS (US); Telynndia Waller, Hattiesburg, MS (US)

(21) Appl. No.: 12/931,343

(22) Filed: Jan. 31, 2011

Related U.S. Application Data
(60) Provisional application No. 61/387,807, filed on Sep. 29, 2010.

(51) Int. Cl. H04R 1/12

(52) U.S. Cl. 381/122

(57) ABSTRACT

These microphone covers may be used by anyone who is concerned about the smells (such as bad breath), and germs (such as colds, HIV, pneumonia, flu) of any sort being transferred, or the feel of another individual's saliva. These covers may be washed with your favorite soap, sprayed with your favorite disinfectant, antiseptic or scent immediately before or after use. The covers are made with as much wrinkle resistance as possible in mind to be easily folded and carried.

### BACKGROUND OR PROBLEM

When using a public microphone, many people become uneasy and concerned because of germs, and odors that may e present on the windscreen. Currently, there is not a suitable quick method for disinfecting a microphone between uses. Saliva, make-up, bacteria, and other contaminants may be present on the microphone. Individuals would prefer to use a device that they feel is sanitary and safe.

### SOLUTION

Microphone windscreen covers offer consumers a washable, disinfectable, reusable, cover for a microphone windscreen in order to help prevent the transmitting of germs and bacteria. The cover can be easily attached to the windscreen to help protect the personal health and hygiene of individuals.

From coming into contact with other individual's saliva, germs, and odors. This helps to make the microphone more sanitary and safe to use. Consumers will appreciate the convenience and practicality that this product provides.

### DETAILED DESCRIPTION OF INVENTION

Microphone Windscreen Cover assists in the protection of individuals from germs and bacteria left on a microphone. The invention is comprised of a cover that fits over the windscreen of varied microphones. The cover is designed to not interfere with sound mechanism. The cover is washable and reusable. It may be secured (in some cases, if if desired) by the use of elastic or a drawstring. It may be made in a variety of colors. It may be washed using a mild soap and cold water, a hand sanitizer, dabbed with alcohol alternatively, sprayed with a germ killing mouthwash or disinfectant. Scents may be added to the cover if desired. Materials and sizes can vary to conform to the different windscreen sizes.

### DETAILED DESCRIPTION OF DRAWINGS ATTACHED

FIGS. 1 through 7 show the product from various perspectives.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable us to best utilize the present invention and various embodiments with various embodiments with various modifications as are suited to the particular use contemplated.

These covers are of any size, shape and color, (with elastic or drawstring if desired) to fit securely over the windscreens of microphones. The standard black cover may be used when being subtle or discreet. Other colors such as gold, silver, etc. may be used to match the users outfits, neckties, background colors of set-ups, etc. A lace or other borders may be added if desired. When your singing or speaking is complete, just remove the cover and put it in your pocket, purse, attaché case, portfolio or wallet and the microphone is ready for the next person's use.

### BRIEF DESCRIPTION OF THE DRAWINGS

FIG. 1 shows a cut of material of actual size for the side view of the microphone windscreen covers. There are only three main pieces to the item itself. This strip is the largest piece.

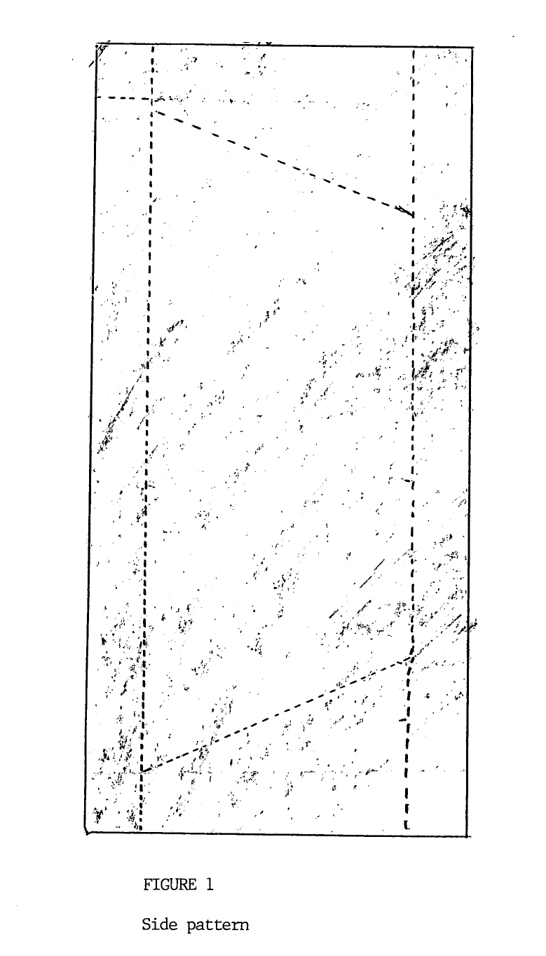

FIG. 2 shows the top that is sewn to the side view.

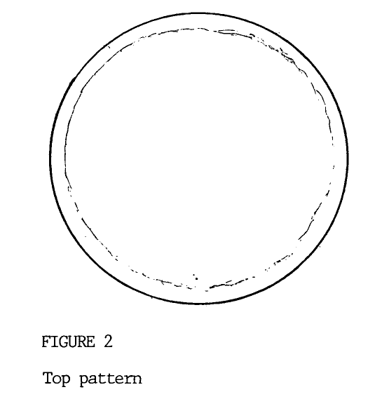

FIG. 3 shows the bias tape piping that is sewn onto the FIG. 1 strip. After the piping is sewn to FIG. 1 then the top piece is connected, making the completed product.

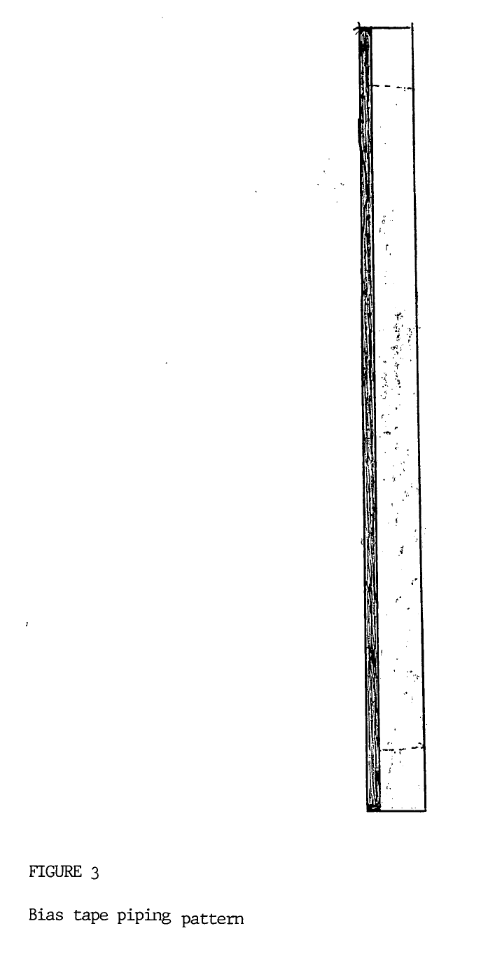

FIG. 4 shows the completed product

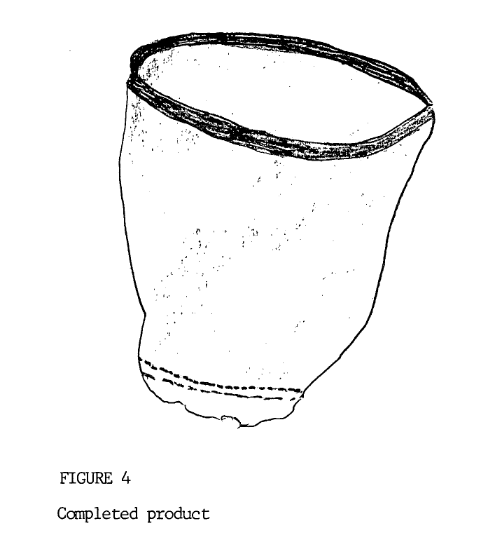

FIG. 5 shows a piece of elastic or draw string that may be added to the completed windscreen especially of a different shape or size.

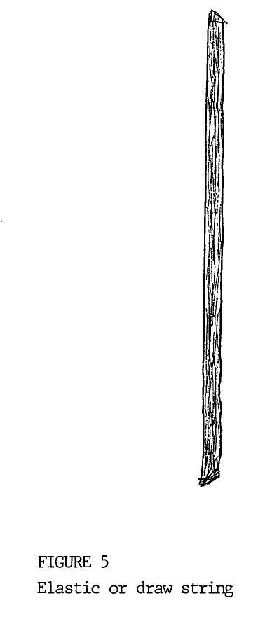

FIG. 6 shows a completed top view of the product

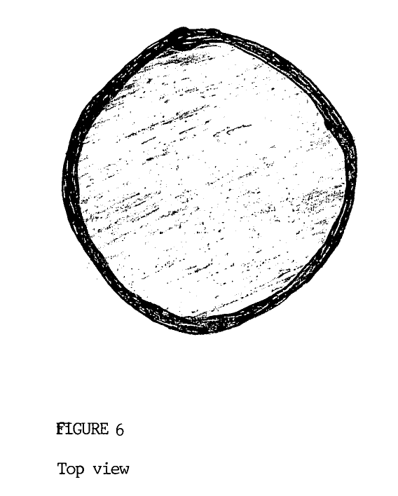

FIG. 7 shows some shapes that may be made for other windscreens. The same three basis pieces are used. These example figures does not limit sizes and/or shapes.

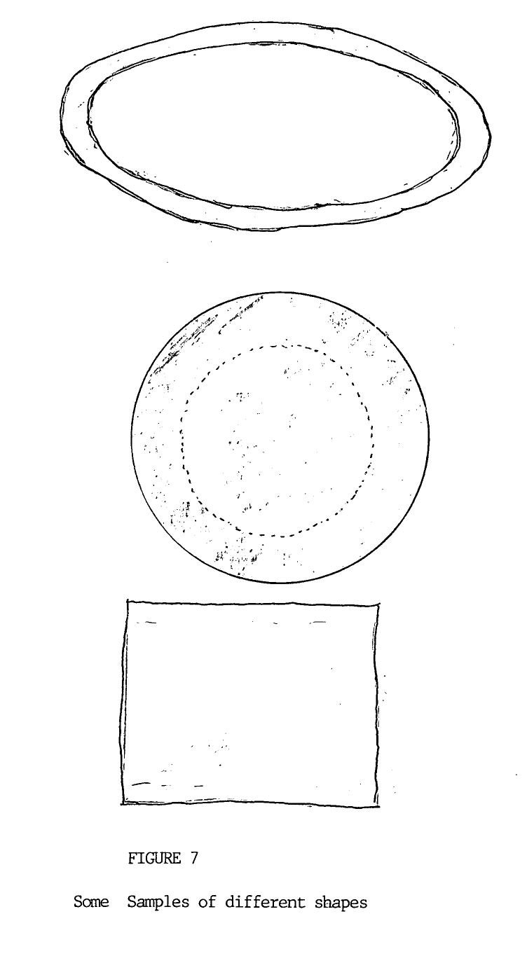

1. Unlike foam covers, these covers are easily cleaned on the spot. They, also, may be disinfected in the same manner. They are easily transported from one program to another and easily adapted to and dismantled from the microphones. Just slip the cover over the windscreen for individual use. When finished speaking or singing, just slip the cover off and you are ready for the next use. You have cut down on your germs being transferred and your catching the germs of others who used the microphone before you.

2. It is further claimed that this particular cover is original.

3. Priority is claimed of provisional application Ser. No. 61/387,807 filed Sep. 29, 2010

4. Small entity is also claimed.
